(19) United States
(12) Patent Application Publication
(10) Pub. No.: US 2025/0079670 A1
(43) Pub. Date: Mar. 6, 2025

(54) CASE AND METHOD OF MANUFACTURING POWER STORAGE CELL

(71) Applicant: TOYOTA JIDOSHA KABUSHIKI KAISHA, Toyota-shi Aichi-ken (JP)

(72) Inventors: Takeru HARA, Toyota-shi Aichi-ken (JP); Masato ONO, Nagoya-shi Aichi-ken (JP); Satoshi MORIYAMA, Nagoya-shi Aichi-ken (JP); Hiroki AWANO, Susono-shi Shizuoka-ken (JP); Kazuya KUMAZAWA, Nagoya-shi Aichi-ken (JP); Seigo FUJISHIMA, Miyoshi-shi Aichi-ken (JP); Tomohiro INAGAKI, Okazaki-shi Aichi-ken (JP)

(73) Assignee: TOYOTA JIDOSHA KABUSHIKI KAISHA, Toyota-shi Aichi-ken (JP)

(21) Appl. No.: 18/812,425

(22) Filed: Aug. 22, 2024

(30) Foreign Application Priority Data
Aug. 29, 2023 (JP) 2023-138994

(51) Int. Cl. H01M 50/627; H01M 50/103

(52) U.S. Cl. CPC H01M 50/627; H01M 50/103

(57) ABSTRACT

A case is used for accommodating an electrode assembly and an electrolyte solution of a power storage cell. The case has a rectangular parallelepiped outer shape. The case includes a first bottom wall, a peripheral wall, and a second bottom wall. The second bottom wall faces the first bottom wall. The peripheral wall connects the first bottom wall and the second bottom wall. The first bottom wall has a rectangular planar shape. The first bottom wall has a long-side direction and a short-side direction. The long-side direction is parallel to a long side of the first bottom wall. The short-side direction is parallel to a short side of the first bottom wall. The first bottom wall is provided with an injection port. The injection port has an aspect ratio of less than 1.

### CROSS REFERENCE TO RELATED APPLICATIONS

This nonprovisional application is based on Japanese Patent Application No. 2023-138994 filed on Aug. 29, 2023 with the Japan Patent Office, the entire contents of which are hereby incorporated by reference.

### BACKGROUND

### Field

The present disclosure relates to a case and a method of manufacturing a power storage cell.

### Description of the Background Art

Japanese Patent Laying-Open No. 2019-145294 discloses an injection port.

### SUMMARY

A power storage cell includes a case, an electrode assembly, and an electrolyte solution. The case accommodates the electrode assembly. The electrolyte solution is injected from an injection port provided in the case. In the case, the electrode assembly is immersed in the electrolyte solution. Conventionally, the injection port has a circular planar shape. That is, the aspect ratio of the injection port is 1. The nozzle is inserted along a central axis of the injection port. The electrolyte solution is jetted from the nozzle. The electrode assembly is disposed directly below the injection port. There is a possibility that the electrolyte solution having hit the electrode assembly bounces back to the injection port side to result in reduced working efficiency.

It is an object of the present disclosure to reduce the bounce of the electrolyte solution.

1. In one aspect of the present disclosure, a case is provided. The case is used for accommodating an electrode assembly and an electrolyte solution of the power storage cell. The case has a rectangular parallelepiped outer shape. The case includes a first bottom wall, a peripheral wall, and a second bottom wall. The second bottom wall faces the first bottom wall. The peripheral wall connects the first bottom wall and the second bottom wall. The first bottom wall has a rectangular planar shape. The first bottom wall has a long-side direction and a short-side direction. The long-side direction is parallel to a long side of the first bottom wall. The short-side direction is parallel to a short side of the first bottom wall. The first bottom wall is provided with an injection port. The injection port has an aspect ratio of less than 1. The aspect ratio indicates a ratio of a maximum diameter of the injection port in the short-side direction to a maximum diameter of the injection port in the long-side direction.

In one aspect of the present disclosure, the injection port has an aspect ratio of less than 1. A nozzle can be inserted obliquely with respect to the central axis of the injection port. The nozzle can be inclined along the long-side direction of the injection port. It is expected to reduce the bounce of the electrolyte solution by jetting the electrolyte solution from the inclined nozzle.

2. The case according to “1” may include, for example, the following configuration. The aspect ratio of the injection port is 0.25 to 0.75.

3. The case according to “1” or “2” may include, for example, the following configuration. The case further includes an inner plate. The inner plate is disposed in the case. The inner plate extends in a direction from the first bottom wall toward the second bottom wall. A through hole is formed in the inner plate.

For example, the electrolyte solution may be jetted with the nozzle being inserted in the through hole of the inner plate. The inner plate may function as a shielding plate. That is, the inner plate is expected to provide shielding against the electrolyte solution that bounces back to the injection port side.

4. In one aspect of the present disclosure, a method of manufacturing a power storage cell is provided. The method of manufacturing the power storage cell includes the following (a) to (d) in this order.

(a) The case according to any one of “1” to “3” is prepared.

(b) The electrode assembly is accommodated in the case.

(c) A nozzle is inserted from the injection port into the case.

(d) The electrolyte solution is injected from the nozzle into the case with the nozzle being inclined in the long-side direction.

It is expected to reduce the bounce of the electrolyte solution by injecting the electrolyte solution with the nozzle being inclined.

5. The method of manufacturing the power storage cell according to “4” may include, for example, the following configuration. In the (a), the case according to “3” is prepared. The (d) includes injecting the electrolyte solution from the nozzle into the case with the nozzle being inserted in the through hole of the inner plate.

It is expected to reduce the bounce of the electrolyte solution by injecting the electrolyte solution with the nozzle being inclined and the nozzle being inserted in the through hole of the inner plate.

Hereinafter, one embodiment (hereinafter, also simply referred to as “the present embodiment”) of the present disclosure will be described. It should be noted that the present embodiment does not limit the technical scope of the present disclosure. The present embodiment is illustrative in any respect. The present embodiment is non-restrictive. The technical scope of the present disclosure includes any modifications within the scope and meaning equivalent to the terms of the claims. For example, it is initially expected to extract freely configurations from the present embodiment and combine them freely.

Geometric terms should not be construed in a strict sense. Examples of the geometric terms include “parallel”, “perpendicular”, “orthogonal”, and the like. For example, the term “parallel” may be deviated to some extent from the strict definition of the term “parallel”. The geometric terms can include, for example, a tolerance, an error, and the like in terms of design, operation, manufacturing, and the like. A dimensional relation in each of the figures may not coincide with an actual dimensional relation. In order to facilitate understanding of the reader, the dimensional relation in each figure may be changed. For example, the length, width, thickness, or the like may be changed. Further, part of configurations may be omitted.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic flowchart of a method of manufacturing a power storage cell according to the present embodiment.

FIG. 2 is a schematic view showing an example of a case according to the present embodiment.

FIG. 3 is a schematic plan view showing a first bottom wall of the case according to the present embodiment.

FIG. 4 is a schematic cross-sectional view illustrating an example of a case according to the present embodiment.

FIG. 5 is a schematic cross-sectional view showing an example of a power storage cell according to the present embodiment.

FIG. 6 is a schematic cross-sectional view illustrating an example of an electrode assembly according to the present embodiment.

### DESCRIPTION OF THE EMBODIMENTS

### 1. Method of Manufacturing Power Storage Cell

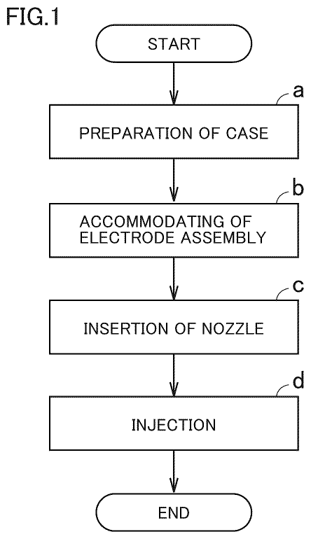

FIG. 1 is a schematic flowchart of a method of manufacturing a power storage cell according to the present embodiment. Hereinafter, the “method of manufacturing a power storage cell in the present embodiment” may be abbreviated as “the manufacturing method”. The manufacturing method includes “(a) preparation of a case”, “(b) accommodating of an electrode assembly”, “(c) insertion of a nozzle”, and “(d) injection” in this order.

### (a) Preparation of Case

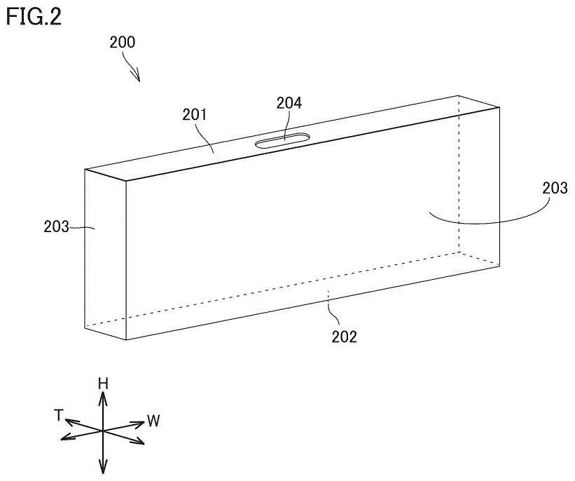

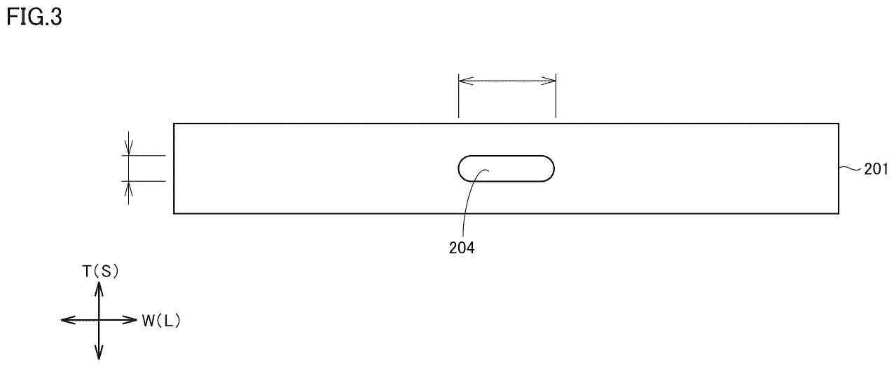

FIG. 2 is a schematic view showing an example of a case according to the present embodiment. FIG. 3 is a schematic plan view showing a first bottom wall of the case according to the present embodiment. The manufacturing method includes providing the case 200. The case 200 may have, for example, a height direction, a width direction, and a thickness direction. The height direction, the width direction, and the thickness direction are orthogonal to each other. The “height direction” is the H direction in FIG. 2 and the like. The “width direction” is the W direction in FIG. 2 and the like. The “thickness direction” is the T direction in FIG. 2 and the like. The height direction may be parallel to the vertical direction, for example. The width direction and the thickness direction may be parallel to the horizontal direction, for example. The “height” indicates the dimension in the height direction. The “width” indicates a dimension in the width direction. The term “thickness” refers to the dimension in the thickness direction or the thickness of an object.

The case 200 may be made of metal, for example. The case 200 may include, for example, Al or the like. The case 200 has a rectangular parallelepiped outer shape. The case 200 includes a first bottom wall 201, a peripheral wall 203, and a second bottom wall 202. The second bottom wall 202 faces the first bottom wall 201 in the H direction. The peripheral wall 203 has a quadrangular tubular shape. The peripheral wall 203 connects the first bottom wall 201 and the second bottom wall 202.

The first bottom wall 201 has a rectangular planar shape. The second bottom wall 202 also has a rectangular planar shape. The first bottom wall 201 has a long-side direction and a short-side direction. The long-side direction is the L direction in FIG. 2. The L direction is parallel to the long side of the contour line of the first bottom wall 201. The L direction is parallel to the W direction. The short-side direction is the S direction in FIG. 2. The S direction is parallel to the short side of the contour line of the first bottom wall 201. The S direction is parallel to the T direction.

An injection port 204 is provided in the first bottom wall 201. In the first bottom wall 201, the injection port 204 may be disposed at any position. The injection port 204 may be disposed, for example, near the center of the first bottom wall 201. The injection port 204 has an aspect ratio of less than 1. The aspect ratio is a ratio of the maximum diameter of the injection port 204 in the S direction to the maximum diameter of the injection port 204 in the L direction. The aspect ratio may be, for example, 0.9 or less, 0.8 or less, 0.7 or less, 0.6 or less, 0.5 or less, 0.4 or less, 0.3 or less, or 0.2 or less. The aspect ratio may be, for example, 0.1 or more, 0.2 or more, 0.3 or more, 0.4 or more, 0.5 or more, 0.6 or more, 0.7 or more, or 0.8 or more. The aspect ratio may be, for example, 0.25 to 0.75.

The maximum diameter of the injection port 204 in the S direction may be, for example, 1 mm or more, 2 mm or more, 3 mm or more, 4 mm or more, 5 mm or more, 6 mm or more, 7 mm or more, 8 mm or more, 9 mm or more, or 10 mm or more. The maximum diameter of the injection port 204 in the S direction may be, for example, 20 mm or less, 10 mm or less, 9 mm or less, 8 mm or less, 7 mm or less, 6 mm or less, 5 mm or less, 4 mm or less, 3 mm or less, 2 mm or less, or 1 mm or less.

As long as the aspect ratio is less than 1, the injection port 204 has any planar shape. The planar shape of the injection port 204 may be, for example, an elliptical shape, a rhombic shape, a rectangular shape, a rounded rectangular shape, or the like.

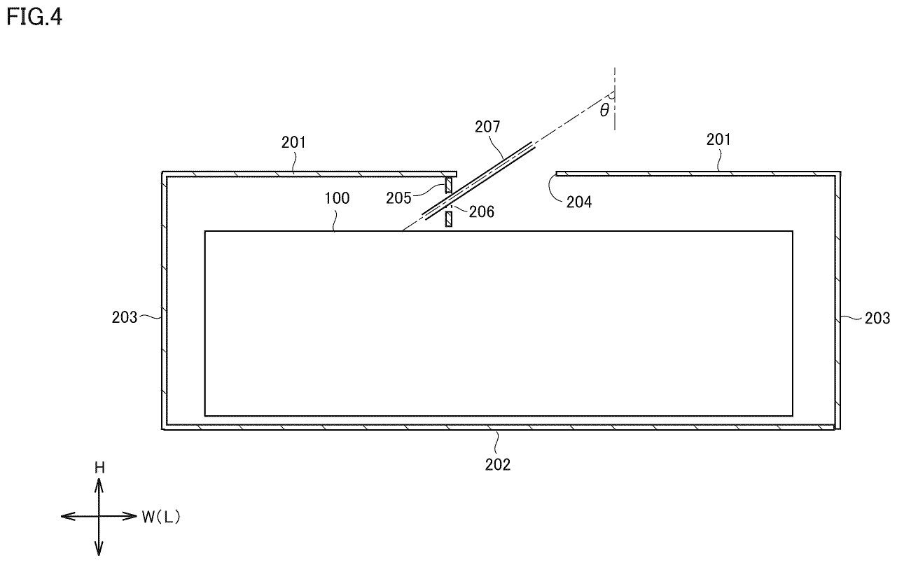

FIG. 4 is a schematic cross-sectional view illustrating an example of a case according to the present embodiment. The case 200 may further include, for example, an inner plate 205. The inner plate 205 may shield bounce of electrolyte solution from the electrode assembly 100. The inner plate 205 may be held by the first bottom wall 201, for example. The inner plate 205 may be held by the peripheral wall 203, for example. The inner plate 205 extends in the H direction. That is, the inner plate 205 extends in a direction from the first bottom wall 201 toward the second bottom wall 202. The inner plate 205 may be parallel to the H direction. The inner plate 205 may be inclined with respect to the H direction. The dimension of the inner plate 205 in the H direction may be set so as not to contact the electrode assembly 100. The inner plate 205 may be adjacent to the end of the injection port 204 in the W direction (L direction). The inner plate 205 may be disposed directly below the end of the injection port 204. The inner plate 205 may be separated from the end of the injection port 204 in the W direction.

The inner plate 205 may have a through hole 206. A nozzle 207 is inserted through the through hole 206. Any planar shape of the through hole 206 in the inner plate 205 is employed. The planar shape of the through hole 206 may be a shape through which the nozzle 207 easily passes. The planar shape of the through hole 206 may be, for example, a circular shape, an elliptical shape, a rounded rectangular shape, or a rectangular shape. The clearance between the through hole 206 and the nozzle 207 may be, for example, 0.1 to 1 mm.

### (b) Accommodating of Electrode Assembly

The manufacturing method includes accommodating the electrode assembly 100 in the case 200. For example, the first bottom wall 201 may constitute a lid. For example, the second bottom wall 202 and the peripheral wall 203 may constitute a container. The container has an opening. The opening may be opened in the H direction, for example. The electrode assembly 100 may be accommodated in the container through the opening. After the electrode assembly 100 is accommodated, the opening is closed by the lid. For example, the lid may be welded to the container by laser machining.

### (c) Insertion of Nozzle

The manufacturing method includes inserting the nozzle 207 into the case 200 from the injection port 204. The nozzle 207 may be inserted through the through hole 206 of the inner plate 205. The nozzle 207 is inserted so as to be inclined with respect to the H direction. The nozzle 207 may be inserted so as to be inclined in the L direction (W direction). The angle (inclination angle θ) between the axial direction of the nozzle 207 and the H direction may be, for example, more than 0°, 5° or more, 15° or more, 30° or more, 45° or more, 60° or more, or 75° or more. The inclination angle θ may be, for example, less than 90°, less than or equal to 75°, less than or equal to 60°, less than or equal to 45°, less than or equal to 30°, less than or equal to 15°, or less than or equal to 5°.

### (d) Injection

The manufacturing method includes injecting the electrolyte solution into the case 200 from the nozzle 207 in a state where the nozzle 207 is inclined in the L direction (W direction). Since the nozzle 207 is inclined, it is considered that the electrolyte solution colliding with the electrode assembly 100 is unlikely to bounce back to the injection port 204 side. When the nozzle 207 is inserted through the through hole 206 of the inner plate 205, the inner plate 205 is expected to block the bounce of the electrolyte solution. Since the bounce of the electrolyte solution is small, for example, the injection rate of the electrolyte solution is expected to be improved.

After a predetermined amount of electrolyte solution is injected, the injection port 204 is closed by the sealing member. The sealing member may be welded to the first bottom wall 201.

### 2. Power Storage Cell

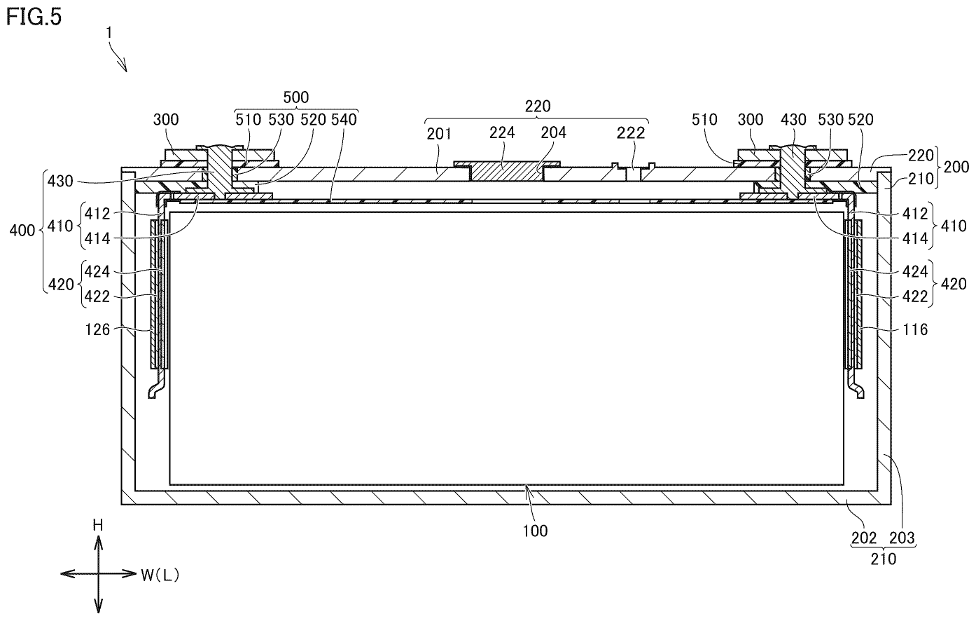

Hereinafter, a power storage cell suitable for the manufacturing method will be described. FIG. 5 is a schematic cross-sectional view showing an example of a power storage cell according to the present embodiment. The power storage cell 1 includes a case 200, an electrode assembly 100, and an electrolyte solution (not shown). The electrolyte solution is a liquid electrolyte. The electrolyte solution may contain, for example, an organic solvent and a lithium salt.

The case 200 accommodates the electrolyte solution and the electrode assembly 100. The case 200 may be hermetically sealed. The case 200 may be sealed. The case 200 may be a single piece. The case 200 may include a plurality of members. The case 200 may include, for example, a container 210 and a lid 220. The container 210 includes a second bottom wall 202 and a peripheral wall 203. The width of the peripheral wall 203 may be greater than the thickness of the peripheral wall 203. The height of the peripheral wall 203 may be greater than the thickness of the peripheral wall 203. Here, the “thickness of the peripheral wall 203” indicates the outer dimension of the case 200 in the T direction.

The lid 220 closes the opening of the container 210. The lid 220 includes a first bottom wall 201. The lid 220 may have, for example, a flat plate shape. The lid 220 may include, for example, a pressure-release valve 222 and a sealing member 224.

The pressure-release valve 222 releases the internal pressure of the case 200. Once the internal pressure becomes equal to or more than the setting value, the pressure-release valve 222 may be opened. The sealing member 224 seals the injection port 204.

The electrode assembly 100 may have, for example, a cubic outer shape. The electrode assembly 100 may have, for example, a rectangular parallelepiped outer shape. The electrode assembly 100 may have, for example, a flat rectangular parallelepiped shape. The electrode assembly 100 may be covered with, for example, an insulating film (not illustrated).

The “first aspect ratio” indicates the ratio of the width to the height in the electrode assembly 100. The first aspect ratio may be, for example, 1 or more, 1.5 or more, 2 or more, 2.5 or more, 3 or more, 5 or more, or 10 or more. The first aspect ratio may be, for example, 10 or less, 5 or less, 3 or less, 2.5 or less, 2 or less, or 1.5 or less. The “second aspect ratio” indicates the ratio of the thickness to the height in the electrode assembly 100. The second aspect ratio may be, for example, 0.1 or more, 0.2 or more, 0.3 or more, 0.5 or more, or 1 or more. The second aspect ratio may be, for example, 1 or less, 0.5 or less, 0.3 or less, or 0.2 or less.

The electrode assembly 100 may have any structure. The electrode assembly 100 may be, for example, a wound type. The electrode assembly 100 may be, for example, a stacked type.

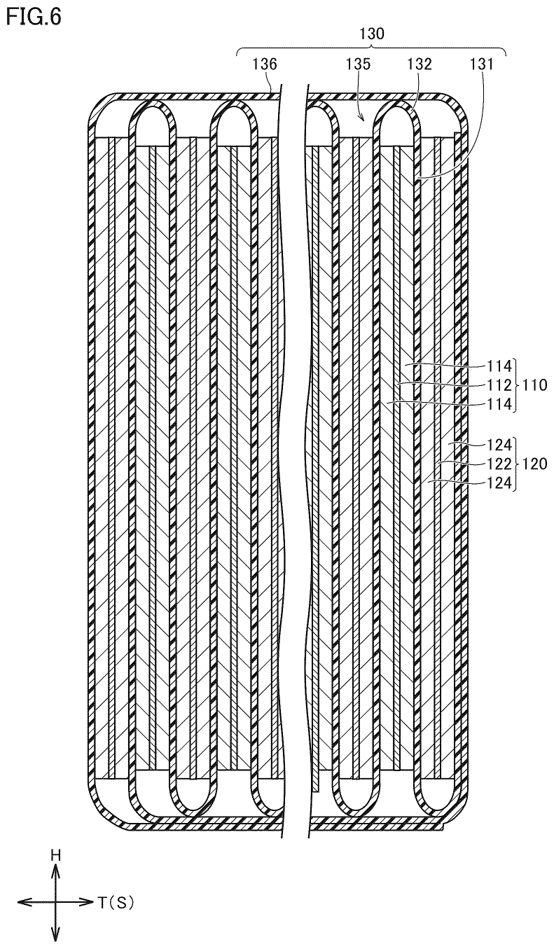

FIG. 6 is a schematic cross-sectional view illustrating an example of an electrode assembly according to the present embodiment. The electrode assembly 100 in FIG. 4 is a stacked type. The electrode assembly 100 includes one or more first electrodes 110, one or more second electrodes 120, and one or more separators 130. In the T direction, the first electrodes 110 and the second electrodes 120 are alternately stacked. That is, the T direction of the power storage cell 1 is parallel to the stacking direction of the first electrode 110 and the second electrode 120. The number of the first electrode 110 and the second electrode 120 may be 2 or more, 5 or more, 10 or more, 50 or more, or 100 or more. The number of each of the first electrode 110 and the second electrode 120 may be 200 or less, 100 or less, 50 or less, 10 or less, or 5 or less.

The second electrode 120 has a polarity different from that of the first electrode 110. For example, the first electrode 110 may be a positive electrode, and the second electrode 120 may be a negative electrode. For example, the first electrode 110 may be a negative electrode, and the second electrode 120 may be a positive electrode.

The first electrode 110 may include, for example, a first current collector 112 and a first active material layer 114. The first current collector 112 may include, for example, a metal foil or the like. The metal foil may contain, for example, Al, Cu, Ni, Ti, Fe, or the like. The first active material layer 114 is disposed on the surface of the first current collector 112. The first active material layer 114 may be disposed on only one surface of the first current collector 112. The first active material layer 114 may be disposed on both surfaces of the first current collector 112. The first active material layer 114 includes a positive electrode active material or a negative electrode active material. The positive electrode active material may include, for example, a lithium-nickel composite oxide or the like. The negative electrode active material may contain, for example, graphite, SiO, Si, or the like.

The second electrode 120 may include, for example, a second current collector 122 and a second active material layer 124. The second current collector 122 may include, for example, a metal foil or the like. The second active material layer 124 is disposed on the surface of the second current collector 122. The second active material layer 124 may be disposed on only one surface of the second current collector 122. The second active material layer 124 may be disposed on both surfaces of the second current collector 122. The second active material layer 124 includes a positive electrode active material or a negative electrode active material. The area of the second active material layer 124 may be the same as or different from that of the first active material layer 114. For example, the area of the second active material layer 124 may be larger than the area of the first active material layer 114. The ratio of the area of the second active material layer 124 to the area of the first active material layer 114 may be, for example, 1.01 or more, 1.05 or more, or 1.1 or more. The ratio of the area of the second active material layer 124 to the area of the first active material layer 114 may be, for example, 1.1 or less, 1.05 or less, or 1.01 or less.

The separator 130 has electrical insulation properties. The separator 130 is porous. The separator 130 may include, for example, a microporous polyolefin film or the like. The thickness of the separator 130 may be, for example, 5 to 50 μm, 5 to 30 μm, or 5 to 15 μm. The separator 130 separates the first electrode 110 from the second electrode 120. For example, two or more separators 130 may be provided. For example, one separator 130 may be inserted between the first electrode 110 and the second electrode 120.

For example, one separator 130 may be provided. For example, separator 130 may include meandering portion 135. In the meandering portion 135, the separator 130 is folded in a meandering shape. The meandering shape may be expressed as, for example, a bellows shape, an accordion shape, or the like.

The meandering portion 135 includes a planar portion 131 and a folded portion 132. In the planar portion 131, the separator 130 extends in a planar shape. In the folded portion 132, the separator 130 is folded back. The folded portions 132 are disposed at both ends in the H direction. The separator 130 is folded so as to alternately sandwich the first electrode 110 or the second electrode 120. The planar portion 131 sandwiches the first electrode 110 or the second electrode 120. Separator 130 may further include, for example, an outer peripheral portion 136. The outer peripheral portion 136 may be wound so as to wrap around the meandering portion 135. The separator 130 may be folded back at both ends in the W direction to form a meandering portion.

The power storage cell 1 further includes an external terminal 300. The pair of external terminals 300 is fixed to the lid 220. The external terminal 300 is connected to the first electrode 110 or the second electrode 120. The external terminal 300 may be made of metal, for example. The external terminal may include Al, Cu, Ni, or the like. The external terminal 300 may have, for example, a rectangular parallelepiped outer shape. The external terminal 300 may be connected to a bus bar (not shown).

The pair of coupling members 400 connects the electrode tab and the external terminal 300. The electrode tab indicates the first electrode tab 116 or the second electrode tab 126. The two coupling members 400 may have substantially the same structure.

The coupling member 400 may include, for example, a current collecting tab 410, a sub-tab 420, and a coupling pin 430. The current collecting tab 410 includes a side portion 412 and an upper portion 414. The side portion 412 is located on the side of the electrode assembly 100 in the W direction. The upper portion 414 is located above the electrode assembly 100. The upper portion 414 extends inward in the W direction from the upper end of the side portion 412.

Sub-tab 420 connects the plurality of electrode tabs to current collecting tab 410. The sub-tab 420 may include a first end 422 and a second end 424. The first end 422 is connected to the plurality of electrode tabs. The second end 424 is connected to the side portion 412.

The coupling pin 430 connects the current collecting tab 410 to the external terminal 300. The coupling pin 430 couples the upper portion 414 and the external terminal 300. For example, the lower end portion of the coupling pin 430 may be inserted into a through hole provided in the upper portion 414.

The insulating member 500 insulates the case 200 from the coupling member 400. The insulating member 500 may include, for example, a first portion 510, a second portion 520, a third portion 530, and a fourth portion 540.

The first portion 510 is fixed to the upper surface of the lid 220. The first portion 510 is disposed between the lid 220 and the external terminal 300. The second portion 520 is fixed to the lower surface of the lid 220. The second portion 520 is disposed between the lid 220 and the upper portion 414. The second portion 520 is disposed between the lid 220 and the lower portion of the coupling pin 430. The third portion 530 is disposed between the coupling pin 430 and the lid 220. The third portion 530 has a tubular shape. The third portion 530 surrounds the coupling pin 430. The first portion 510, the second portion 520, and the third portion 530 are provided with through holes. The coupling pin 430 is inserted through the through hole.

The fourth portion 540 has a plate shape. It is fixed to the lower surface of the upper portion 414. The fourth portion 540 is disposed above the electrode assembly 100. In the fourth portion 540, a through hole is provided below the pressure-release valve 222. In the fourth portion 540, a through hole is also provided below the injection port 204.

What is claimed is:

1. A case for accommodating an electrode assembly and an electrolyte solution of a power storage cell, wherein
the case has a rectangular parallelepiped outer shape,
the case includes a first bottom wall, a peripheral wall, and a second bottom wall,
the second bottom wall faces the first bottom wall,
the peripheral wall connects the first bottom wall and the second bottom wall,
the first bottom wall has a rectangular planar shape,
the first bottom wall has a long-side direction and a short-side direction,
the long-side direction is parallel to a long side of the first bottom wall,
the short-side direction is parallel to a short side of the first bottom wall,
the first bottom wall is provided with an injection port,
the injection port has an aspect ratio of less than 1, and
the aspect ratio indicates a ratio of a maximum diameter of the injection port in the short-side direction to a maximum diameter of the injection port in the long-side direction.

2. The case according to claim 1, wherein the aspect ratio is 0.25 to 0.75.

3. The case according to claim 1, further comprising an inner plate, wherein
the inner plate is disposed in the case,
the inner plate extends in a direction from the first bottom wall toward the second bottom wall, and
a through hole is formed in the inner plate.

4. A method of manufacturing a power storage cell, the method comprising the following (a) to (d) in this order:
(a) preparing the case according to claim 1;
(b) accommodating the electrode assembly in the case;
(c) inserting a nozzle from the injection port into the case; and
(d) injecting the electrolyte solution from the nozzle into the case with the nozzle being inclined in the long-side direction.

5. The method of manufacturing the power storage cell according to claim 4, wherein
in the (a), the case according to claim 3 is prepared,
the (d) includes injecting the electrolyte solution from the nozzle into the case with the nozzle being inserted in the through hole of the inner plate.
